(19) United States
(12) Patent Application Publication
(10) Pub. No.: US 2015/0256421 A1
(43) Pub. Date: Sep. 10, 2015

(54) INFORMATION PROCESSING METHOD AND INFORMATION PROCESSING APPARATUS

(71) Applicant: FUJITSU LIMITED, Kawasaki-shi (JP)

(72) Inventor: Tsutomu KAWAI, Kawasaki (JP)

(21) Appl. No.: 14/624,716

(22) Filed: Feb. 18, 2015

(30) Foreign Application Priority Data
Mar. 7, 2014 (JP) 2014-045496

(51) Int. Cl. H04L 12/26

(52) U.S. Cl. CPC H04L 43/04; H04L 43/08

(57) ABSTRACT

A program stored in a computer-readable medium causes a computer to execute a process including obtaining a plurality of measurement values measured by a plurality of sensors provided in a physical server; calculating displacement values of the measurement values for the threshold values with respect to each threshold value of the load patterns which indicate combinations of threshold values of the measurement values corresponding to types of the plurality of sensors, each threshold value is stored in a storage unit; and outputting the displacement values of the measurement values and the threshold values of the measurement values.

### CROSS-REFERENCE TO RELATED APPLICATION

This application is based upon and claims the benefit of priority of the prior Japanese Patent Application No. 2014-045496, filed on Mar. 7, 2014, the entire contents of which are incorporated herein by reference.

### FIELD

The present invention relates to optimization of information processing of resources.

### BACKGROUND

In the IaaS (Infrastructure as a Service) of cloud computing, forms of providing resources to clients have been expanded from virtual machine units to physical machine units. That is, it has become possible for clients to demand resources in virtual machine units or physical machine units.

There are cases where, for the selection of a unit of resources, that is, the selection of whether the resources will be provided in physical machine units or in virtual machine units according to a client's requirement, a client's selection is not done appropriately. For example, despite a physical machine being provided to the client, there is a case where only resources of one virtual machine out of the provided physical machines are used.

If the selection of the unit that provides resources is appropriate, the service provider can improve the utilization efficiency of the overall system by optimizing the resources and the client can reduce the cost. Therefore, the service provider is required to encourage suitable selection of the form of provision of resources (unit of provisions) by notifying the client of the suitable unit of provision of resources for a use condition.

Techniques described in the following literature are known.

Japanese Laid-open Patent Publication No. 2012-94129

Japanese Laid-open Patent Publication No. 2011-141908

International Publication Pamphlet No. WO 2010/140183

### SUMMARY

According to one aspect, a computer-readable recording medium having stored therein a program for causing a computer to execute a process including, obtaining a plurality of measurement values measured by a plurality of sensors provided in a physical server; calculating displacement values of the measurement values for the threshold values with respect to each threshold value of the load patterns which indicate combinations of threshold values of the measurement values corresponding to types of the plurality of sensors, each threshold value being stored in a storage unit; and outputting the displacement values of the measurement values and the threshold values of the measurement values.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a functional block diagram illustrating a configuration of an example of an information processing apparatus according to the embodiment.

FIG. 2 is an example of a configuration of an information processing system according to the embodiment.

FIG. 3 illustrates an example of a measurement value table.

FIG. 4 illustrates an example of a configuration of an outside air temperature correction table.

FIG. 5 illustrates an example of a configuration of a fan cooling correction table.

FIG. 6 illustrates an example of a configuration of a reference value table.

FIG. 7 illustrates an example of a configuration of a coefficient conversion table.

FIG. 8 illustrates an example of a displacement table.

FIG. 9 illustrates an example of a suitability determination table.

FIG. 10 is an example of an output screen when suitability information on the form of provision by the provisioning server and load state of the provisioning server is output.

FIG. 11 is a flow chart diagrammatically illustrating in detail a processing operation for estimating the load state of the provisioning server.

FIG. 12 is a flow chart diagrammatically illustrating in detail an outside air temperature correction processing operation.

FIG. 13 is a flow chart diagrammatically illustrating in detail a fan cooling correction processing operation.

FIG. 14 is a flow chart diagrammatically illustrating details of a processing operation of a determination processing operation of the suitability of the form of provision of the provisioning server.

FIG. 15 is a flow chart diagrammatically illustrating in detail an output processing operation.

FIG. 16 illustrates an example of a hardware configuration of a management server.

### DESCRIPTION OF THE EMBODIMENTS

The determination of the unit of provision of resources suitable for a use condition is possible if an agent (software) that collects information about the usage of the server can be stationed in such a physical server that is provided to clients. However, in view of information privacy and security, it is not possible to station the agent in such an above-mentioned physical server that is provided to clients.

The information processing according to the embodiment can provide information for selecting the form of application of the more desirable resources, depending on the external environment of the physical server.

Service providers cannot station an agent that collects information about the usage in physical servers providing resources to clients (hereinafter, referred to as a provisioning server). Here, the information processing apparatus according to the embodiment determines the suitability of the form of provision of resources by using information about the external environment that can be collected from the provisioning server.

As an example of information that the service provider can obtain from the provisioning server, sensor information collected for managing temperature and for detecting failures of the provisioning server can be given. More specifically, such sensor information for example includes power consumption of the overall physical server, power consumption of a Central Processing Unit (CPU), and power consumption of a Peripheral Component Interconnect (PCI). In another example, the sensor information is a rotational speed of the fan installed in certain positions in the servers, and temperature information on certain positions in the server, etc.

Using the collectable information, the information processing apparatus determines the suitability of the form of provision of the resources. Specifically, the information processing apparatus obtains the sensor information in a specified period from the provisioning server. The information processing apparatus stores in advance, for each load state of the physical server, a reference value of the sensor information of the physical server at the time of each state (threshold value). Each of these load states is associated with the suitability information indicating whether the load state is more suitable for a physical server or a virtual server. The information processing apparatus then compares the obtained sensor information to the reference value of the sensor information for each load state previously stored in advance and calculates at a specified time the similarity (displacement) between the provisioning server and each load state. The information processing apparatus determines the suitability of the form of provision of the provisioning server on the basis of the calculated similarity (displacement) and the suitability information.

In this way, the information processing apparatus according to the embodiment can verify the suitability of the selection of the unit of provision of resources, without stationing an agent in the provisioning server. In addition, the information processing apparatus according to the embodiment, while taking into consideration the policy relating to the collection of client information, can be performed to understand the use condition of the provisioning server.

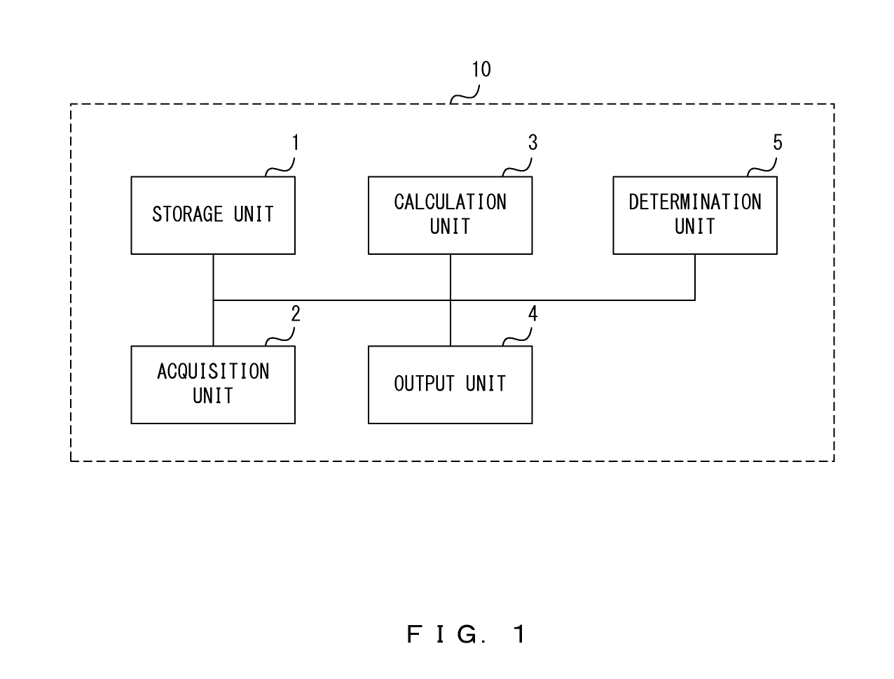

FIG. 1 is a functional block diagram illustrating a configuration of an embodiment of an information processing apparatus according to the embodiment. In FIG. 1, the information processing apparatus 10 includes a storage unit 1, an acquisition unit 2, a calculation unit 3, an output unit 4, and a determination unit 5.

The storage unit 1 stores therein a load pattern indicating a combination of threshold values corresponding to the type of a plurality of sensors provided in the physical server.

The acquisition unit 2 obtains a plurality of measurement values that have been measured by a plurality of sensors provided in the physical server.

The calculation unit 3 calculates for each threshold value of the load pattern, the displacement values of the measurement values from the threshold values.

The output unit 4 outputs the displacement values of the measurement values and the threshold values of the measurement values.

The storage unit 1 stores therein, in association with a load pattern, application information indicating whether a physical server is able to be applied to a virtual server.

The determination unit 5, in accordance with the displacement values of the measurement values aggregated for each piece of application information stored in the storage unit 1, performs determination of the applicability of the physical server to the virtual server.

The output unit 4 outputs the result of the determination.

The calculation unit 3 calculates for each load pattern the sum of the difference between a plurality of measurement values and the corresponding threshold value of the types of the sensors that measured the measurement value.

The determination unit 5, in accordance with the ratio of the sum of the difference of each pattern to the sum of the differences of the plurality of patterns, performs determination of whether the physical server is applicable to the virtual server.

When, for the sum of the difference of a plurality of patterns, the total ratio of the sum of the differences of the plurality of patterns that are able to be applied to the virtual server is less than a specified threshold value, the determination unit 5 determines that the physical server is applicable to the virtual server.

The storage unit 1 stores therein correction information about a value that does not depend on the load state of the physical server.

The calculation unit 3, based on the correction information stored in the storage unit 1, corrects a plurality of measurement values and calculates the displacement values between the corrected measured value and a threshold value corresponding to the type of the sensor that measured the measurement value.

Thus, the operation state of the physical server can be presented together with an indication of whether the physical server is applicable to the virtual server by outputting the threshold value and the displacement values of the measurement value obtained by the physical server from the threshold value of each sensor stored in advance.

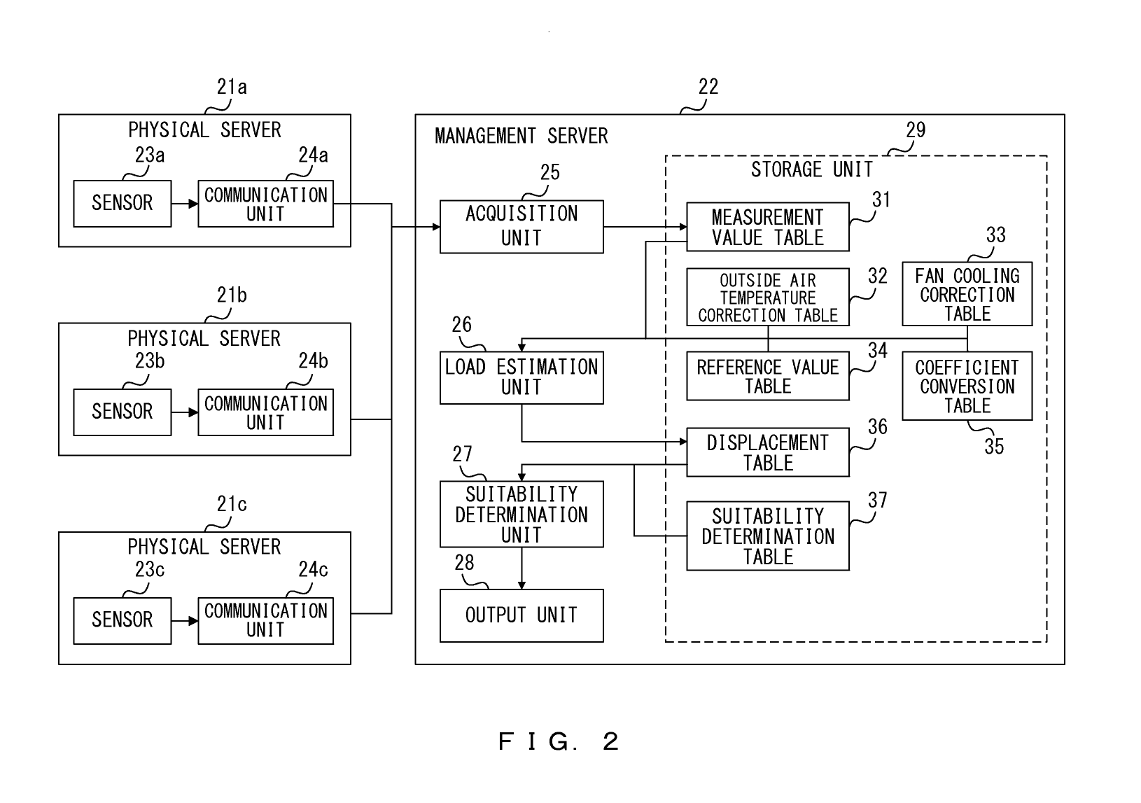

FIG. 2 is an example of a configuration of an information processing system according to the embodiment. The information processing system includes a plurality of physical servers 21 (21a, 21b, 21c) and a management server 22. The physical server 21 is an example of a physical server (provisioning server) that is provided to a client by a service provider. The management server 22 is an example of a server managed by the service provider. Each physical server 21 is connected to the management server 22 via a communication network such as local area network, for example. The management server 22 collects the sensor information from each physical server 21 and determines the suitability of the form of provision of the physical server 21.

Each of the physical servers 21 (21a, 21b, 21c) includes one or more sensors 23 (23a, 23b, 23c) and communication units 24 (24a, 24b, 24c).

The sensor 23 is a sensor for measuring the information that can be collected by the service provider. Specifically, for example, the sensor 23 is a sensor for measuring power consumption of the entire physical server, power consumption of the CPU, power consumption of the PCI, rotational speed of the fan, temperature, etc.

The sensor for measuring the rotational speed of the fan of the physical server 21, for example, includes sensors for measuring the rotational speed of fans to be installed in multiple locations on the system board of the physical servers 21, and for measuring the rotational speed of the fan attached to a Power Supply Unit (PSU). The sensor for measuring temperature includes, for example, sensors for measuring an outside air temperature (intake air temperature) of the physical server 21, for measuring the temperature of a specified position on the mother board, the temperature of the CPU, and for measuring the temperature of the Voltage-Regulator (VR) of the CPU. Other sensors for measuring the temperature include, for example, sensors for measuring the temperature of a memory, the temperature of a VR of the memory, and of the PSU.

The communication unit 24 obtains, from one or more sensors 23, sensor information measured by each of the sensors 23 and transmits the information to an acquisition unit 25 of the management server 22.

The functions of the communication unit 24 may be implemented by a dedicated hardware capable of providing the functions without depending on the OS (Operating System) of the physical server or the power state, or may be implemented by a processor.

The management server 22 includes the acquisition unit 25, a load estimation unit 26, a suitability determination unit 27, an output unit 28, and a storage unit 29. The management server 22 is an example of the information processing apparatus 10. The acquisition unit 25 is an example of the acquisition unit 2. The load estimation unit 26 is an example of the calculation unit 3. The suitability determination unit 27 is an example of the determination unit 5. The output unit 28 is an example of the output unit 4. The storage unit 29 is an example of the storage unit 1.

The acquisition unit 25 collects sensor information from each physical server 21. The load estimation unit 26 estimates (determines) the load state of the physical server 21 by comparing the sensor information collected by the acquisition unit 25 and the reference value for each load state stored in the storage unit 29. The suitability determination unit 27 determines the suitability of the form of provision by the provisioning server in accordance with the load state of the physical servers estimated by the load estimation unit 26. The output unit 28 outputs information of the suitability of the form of provision determined by the suitability determination unit 27. The storage unit 29 stores therein information to be used by the acquisition unit 25, the load estimation unit 26, the suitability determination unit 27, and the output unit 28. Specifically, as will be described later, the storage unit 29 stores an outside air temperature correction table 32, a fan cooling correction table 33, a reference value table 34, a coefficient conversion table 35, and a suitability determination table 37 in advance. The storage unit 29 also stores a measurement value table 31 generated by the acquisition unit 25 and a displacement table 36 generated by the load estimation unit 26.

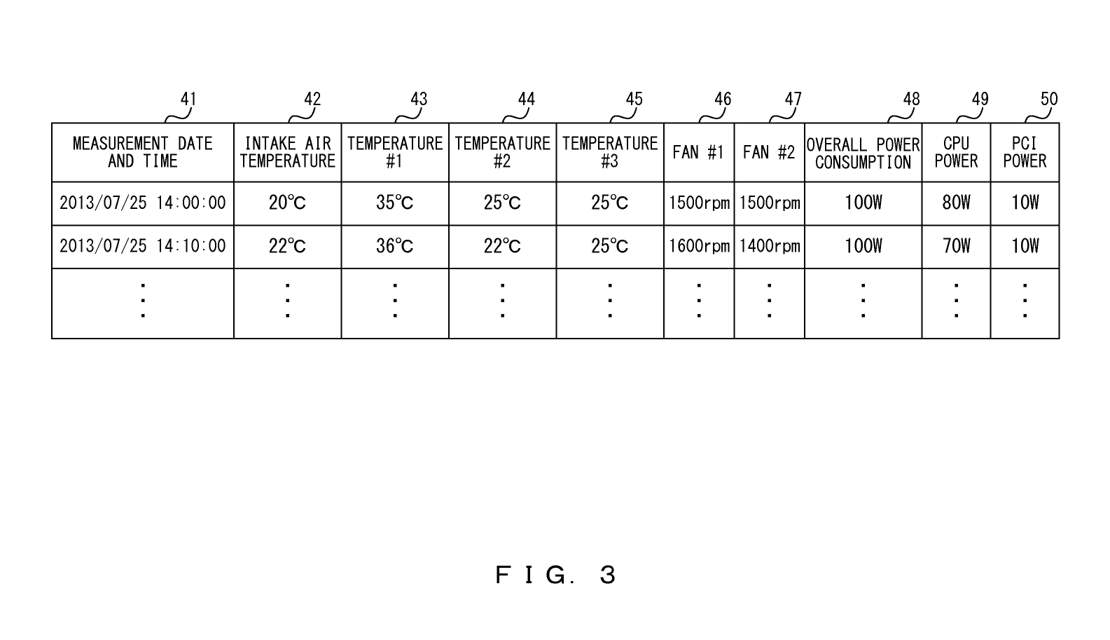

The acquisition unit 25 obtains sensor information from the communication unit 24 of each physical server 21 and stores the information in the measurement value table 31 stored in the storage unit 29. FIG. 3 illustrates an example of the measurement value table 31. In the measurement value table 31 of FIG. 3, the measurement value of each sensor of the physical server is recorded in association with the date and time of the measurement values. The measurement value table 31 stores therein the items “measurement date and time” 41, “intake air temperature” 42, “temperature #1” 43, “temperature #2” 44, “temperature #3” 45, “fan #1” 46, “fan #2” 47, “overall power consumption” 48, “CPU power” 49 and “PCI power” 50 in association with each other. In addition, “intake air temperature” 42, “temperature #1” 43, “temperature #2” 44, “temperature #3” 45, “fan #1” 46, “fan #2” 47, “overall power consumption” 48, “CPU power” 49, and “PCI power” 50 are associated with each sensor that is installed on physical server respectively.

The “measurement date and time” 41 indicates the date and time at which each sensor 23 obtained the sensor information. The “intake air temperature” 42 indicates the intake air temperature measured at the corresponding “measurement date and time” 41 by the sensor that measures the intake air temperature of the physical servers. The “temperature #1” 43, “temperature #2” 44, and “temperature #3” 45 respectively indicate the measured temperature at the corresponding “measurement date and time” 41 measured by temperature sensors that measure the temperature of the mutually different specified positions of the physical server. The “fan #1” 46 and “fan #2” 47 respectively indicate the measured rotational speed of the fan at the corresponding “measurement date and time” 41 measured by a sensor for measuring the rotational speed of the fan installed on the physical server. The “overall power consumption” 48, the “CPU power” 49, and the “PCI Power” 50 respectively indicate the measured power consumption at the corresponding “measurement date and time” 41 measured by a sensor for measuring the power consumption of the overall consumption power, the power consumption of the CPU, and the power consumption of the PCI of the physical servers.

A plurality of measurement value tables 31 are generated and each measurement value table 31 is managed by uniquely associating them with each physical server out of a plurality of physical servers that are made subject to the suitability determination by the management server.

The load estimation unit 26 estimates the load state of the physical server by using the data of the measurement value table 31 and the reference value of the sensor information for each load state stored in advance in the storage unit 29.

In the estimation of the load states, the load estimation unit 26 first performs correction processing to remove the effects of each physical server or the environment in which the physical server is installed from the values of the measurement value table 31.

For example, the measurement value of the temperature sensor of the physical server is not only affected by the load state of the physical servers, but also by the temperature (intake air temperature) of the location where the physical server is installed. Moreover, the measurement value measured by the temperature sensors of the physical servers, for example, is also affected by the cooling of the fan of the physical servers. In order to remove such influence to the measurement values other than the load state, the load estimation unit 26 corrects the value of the measurement value table 31 by using a correction table which is stored in advance in the storage unit 29.

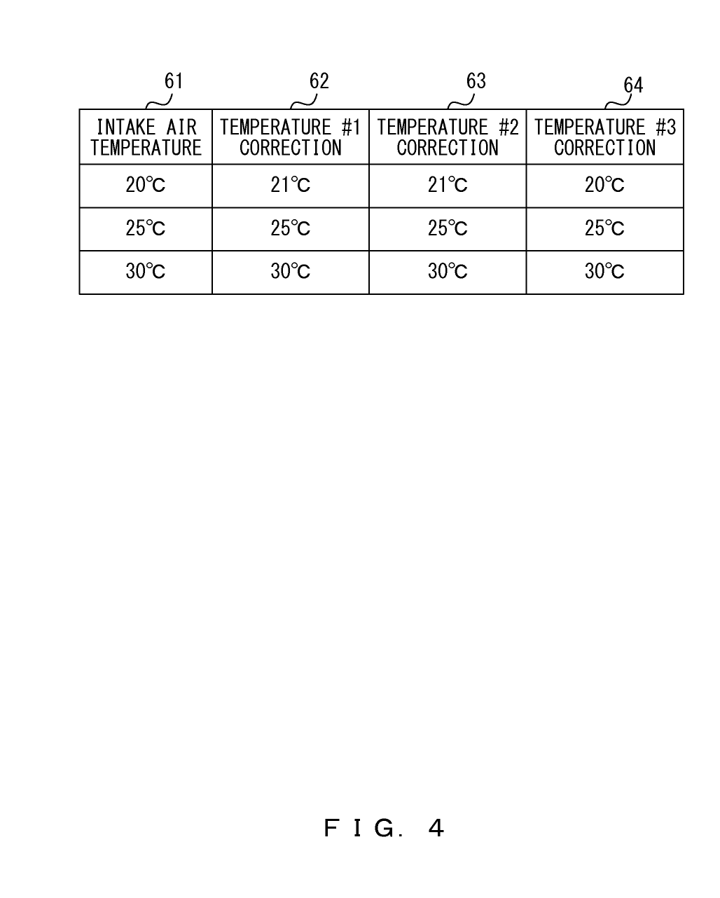

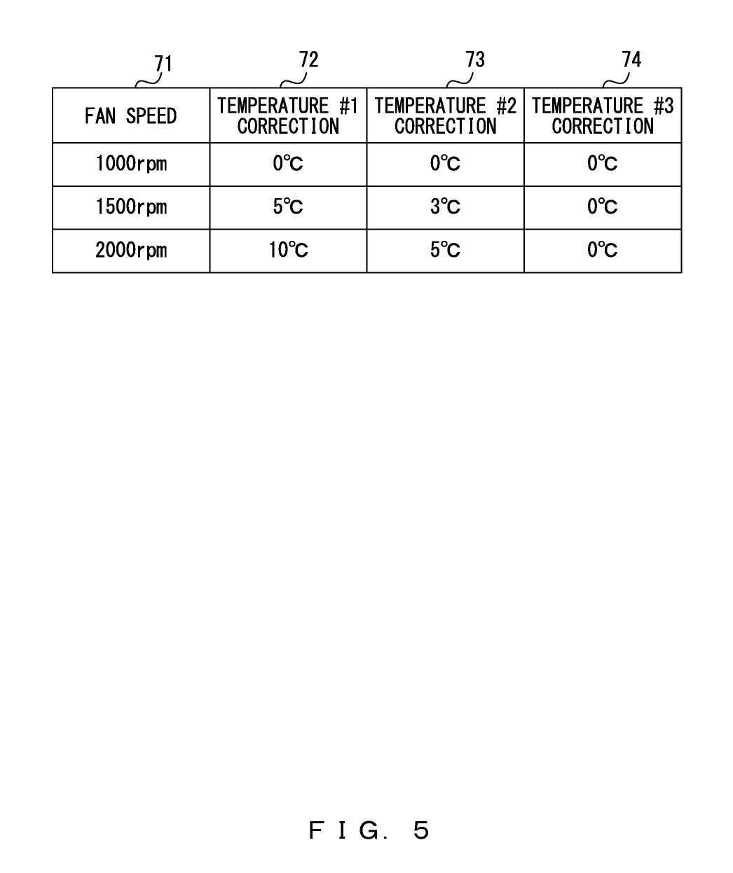

Specifically, the information processing apparatus of the present embodiment performs correction of the measurement value by using the outside air temperature correction table 32 to remove the effects of temperature, and by using a fan cooling correction table 33 to remove the effects of the fan. FIG. 4 illustrates an example of a configuration of the outside air temperature correction table 32. FIG. 5 illustrates an example of a configuration of the fan cooling correction table 33.

The outside air temperature correction table 32 stores the intake air temperature in association with the correction value corresponding to each temperature sensor installed on the physical server. In FIG. 4, the outside air temperature correction table 32 stores the data items of “intake air temperature” 61, “temperature #1 correction” 62, “temperature #2 correction” 63, and “temperature #3 correction” 64 in association with each other.

The “intake air temperature” 61 indicates the value of the intake air temperature measured by the sensor that measures the intake air temperature of the physical server. The “temperature #1 correction” 62, “temperature #2 correction” 63, and the “temperature #3 correction” 64 respectively indicate the correction value for the measurement value of the temperature sensor installed in each position of the physical servers, when the measurement value of the sensor for measuring the intake air temperature of the physical server is indicated with “intake air temperature” 61. The “temperature #1 correction” 62, the “temperature #2 correction” 63, and the “temperature #3 correction” 64 in FIG. 4 respectively indicate the correction values of the “temperature #1” 43, the “temperature #2” 44, and the “temperature #3” 45 in FIG. 3.

The fan cooling correction table 33 stores the rotational speed of the fan installed on the physical server in association with the correction value corresponding to each temperature sensor. If a plurality of fans is installed on the physical servers, a plurality of cooling fan correction tables 33 are stored in association with each fan in the storage unit 29.

In FIG. 5, the fan cooling correction table 33 includes the data items “fan speed” 71, “temperature #1 correction” 72, “temperature #2 correction” 73, and “temperature #3 correction” 74.

The “fan speed” 71 indicates the value of the rotational speed of the fan corresponding to the fan cooling correction table 33. For example, when the fan cooling correction table 33 corresponds to the fan indicated by “fan #1” 46, then the “fan speed” 71 indicates the rotational speed of the fan indicated by “fan #1” 46. The “temperature #1 correction” 72, the “temperature #2 correction” 73 and the “temperature #3 correction” 74 respectively indicate a correction value corresponding to the measurement value of the temperature sensor installed in a specified position of the physical server when the rotational speed of the corresponding fan is a value indicated by the “fan speed” 71. The “temperature #1 correction” 72, the “temperature #2 correction” 73, and the “temperature #3 correction” 74 in FIG. 5 respectively indicate the correction values of “temperature #1” 43, “temperature #2” 44, and “temperature #3” 45 in FIG. 3.

When correcting the value of the measurement value table 31 by using the outside air temperature correction table 32, the load estimation unit 26 first refers to the value of the “intake air temperature” 42 of the measurement value table 31. Then, the load estimation unit 26 obtains a correction value corresponding to the referenced value of the “intake air temperature” 42 by referring to the outside air temperature correction table 32. That is, the load estimation unit 26 obtains the values of the “temperature #1 correction” 62, the “temperature #2 correction” 63, and the “temperature #3 correction” 64 in the row in which the value of the “intake air temperature” 61 is equal to the value of the “intake air temperature” 42 in the outside air temperature correction table 32. Then, the load estimation unit 26 calculates the measurement value after correction, according to the following Equation (1).

Measurement value after correction=measurement value−intake air temperature+correction value (1)

Specifically, for example, let's consider a case where the value of the “temperature #1” 43 (“35° C.”) in the row in which the value of the “measurement date and time” 41 is “2013/07/25 14:00:00” of the measurement value table 31 in FIG. 3 is to be corrected. In this case, since the value of the “intake air temperature” 42 in the row of “2013/07/2514:00:00” is “20° C.”, the load estimation unit 26 obtains the value of the “temperature #1 correction” 62 in the row in which the value of the “intake air temperature” 61 is “20° C.” in the outside air temperature correction table 32. In the outside air temperature correction table 32 of FIG. 4, the value of the “temperature #1 correction” 62 in the row in which the value of the “intake air temperature” 61 is “20° C.” is “21° C.”. Then, the load estimation unit 26, by using equation (1), calculates the measurement value after correction. In other words, the value after correction of the “temperature #1” 43 in the row in which the value of the “measurement date and time” 41 is “2013/07/25 14:00:00” is, the value after correction of the measurement value, =“35° C.”−“20° C.”+“21° C.”=“36° C.”.

When the value of the “intake air temperature” 42 of the measurement value table 31 is not present in the column of the “intake air temperature” 61 of the outside air temperature correction table 32, the load estimation unit 26 calculates a correction value by performing a linear interpolation. That is, when assuming X for the value of the “intake air temperature” 42, which does not exist in the column of “intake air temperature” 61 of the outside air temperature correction table 32, the load estimation unit 26 obtains the values Xᵢ and Xᵢ₊₁ to give Xᵢ≦X≦Xᵢ₊₁, which is the value of the “intake air temperature” 61 of the outside air temperature correction table 32. Then, when assuming a correction value Yᵢ corresponding to Xᵢ, and a correction value Yᵢ₊₁ corresponding to Xᵢ₊₁, the correction value is calculated by the following equation.

Correction value by linear interpolation=Yᵢ+(Yᵢ₊₁−Yᵢ)*(X−Xᵢ)/(Xᵢ₊₁−Xᵢ) (2)

For example, let's consider a case where the value of the “temperature #2” 44 (“22° C.”) in the row in which the values of the “measurement date and time” 41 is “2013/07/25 14:10:00” of the measurement value table 31 in FIG. 3 is to be corrected. In this case, the load estimation unit 26 first obtains the value “22° C.” of the “intake air temperature” 42 in the row where the value of the “measurement date and time” 41 is “2013/07/25 14:10:00” in the measurement value table 31. Then the load estimation unit 26 determines whether or not the row where the value of the “intake air temperature” 61 is “22° C.” exists in the outside air temperature correction table 32. Here, no row exists where the value of the “intake air temperature” 61 is “22° C.”. In this case, the load estimation unit 26 calculates the correction value in the case where the value of the “outside air temperature” 61 is “22° C.” by performing linear interpolation on the basis of the values in the rows where the values of the “intake air temperature” 61 is “20° C.” and “25° C.” in the outside air temperature correction table 32. Here, the value of the “temperature #2 correction” 63 of the rows where the values of the “intake air temperature” 61 is “20° C.” and “25° C.” are, respectively, “21° C.” and “25° C.”. In this case, the load estimation unit 26 calculates the correction value to be=21+((25−21)*(22−20)/(25−20))=22.6 according to linear interpolation by using Equation (2).

Then, the load estimation unit 26 calculates the measurement value after correction by using Equation (1). In other words, the value after correction of “temperature #2” 44 in the row where the value of the “measurement date and time” 41 is “2013/07/25 14:10:00”, is, the value after correction of the measurement value, =“22° C.”−“22° C.”+“22.6° C.”=“22.6° C.

When correcting the value of the measurement value table 31 by using the fan cooling correction table 33 corresponding to the “fan #1”, the load estimation unit 26 first refers to the value of the “fan #1” 46 of the measurement value table 31. Next, the load estimation unit 26 obtains a correction value corresponding to the referenced value of the “fan #1” 46 by referring to the fan cooling correction table 33. That is, the load estimation unit 26 obtains the values of the “temperature #1 correction” 72, the “temperature #2 correction” 73, and the “temperature #3 correction” 74 in the row where the value of the “fan speed” 71 in the fan cooling correction table 33 is equal to the value of the “fan #1” 46.

If the value of the “fan #1” 46 is not present in the column of the “fan speed” 71 in the fan cooling correction table 33, the load estimation unit 26 calculates the correction value by linear interpolation in the same way as with the outside air temperature correction. Then, the load estimation unit 26 calculates the measurement value after correction, according to the following Equation (3).

Measurement value after correction=measurement value−correction value (3)

For example, when correcting the value of the “temperature #1” 43 (“36° C.”) in the row in which the values of the “measurement date and time” 41 is “2013/07/25 14:10:00” in the measurement value table 31 in FIG. 3, the load estimation unit 26 obtains the value “1600 rpm” of the “fan #1” 46 of the row “2013/07/25 14:10:00”. Then, the load estimation unit 26 determines whether or not the row where the value of the “fan speed” 71 is “1600 rpm” exists in the fan cooling correction table 33 corresponding to the fan #1 in FIG. 5. Here, no row where the value of the “fan speed” 71 is “1600 rpm” exists in the fan cooling correction table 33. In this case, the load estimation unit 26 calculates the correction value when the “fan speed” 71 is “1600 rpm” by performing linear interpolation based on the values of the “temperature #1 correction” 72 (“5° C.” and “10° C.) in the rows where the value of the “fan speed” 71 is “1500 rpm” and “2000 rpm” in the fan cooling correction table 33. That is, the load estimation unit 26 calculates the correction value=5+((10−5)*(1600−1500)/(2000−1500))=6 according to linear interpolation by using the Equation (2).

Then, the load estimation unit 26 calculates the measurement value after correction by using Equation (3). That is, the value after correction of the measurement value of the “temperature #1” 43 in the row where the value of the “measurement date and time” 41 is “2013/07/25 14:10:00” is measurement value after correction=“36° C.”−“6° C.”=“30° C.”.

After calculating the measurement value after correction, the load estimation unit 26 updates each measurement value of the measurement value table 31 with the calculated measurement value after correction. In addition, for example, when performing fan cooling correction after the outside air temperature correction, the fan cooling correction will be performed for the measurement value after the outside air temperature correction.

Note that methods of removing the effects on measurement values of each sensor due to factors other than the load state are not limited to the method of removing the effects of outside air temperature or the fan. A variety of other factors may be considered.

When correcting the value of the measurement value table 31, as described above, the load estimation unit 26 compares the measured value of the corrected measurement value table 31 with the reference value for each load state of the reference value table 34, to determine (estimate) the load state of the physical server at the measurement date and time of the measurement value.

The reference value table 34 is information indicating a combination of a reference value (threshold value) of the sensor information for each load state of the physical server. The load state of the physical server includes, for example, a state in which there is a load on the CPU (referred to as the CPU load state), a state in which there is a load on an IO (referred to as an IO load state), and a state in which there is no load (referred to as a no-load state). The reference value table 34 in which identification information identifying the load state and reference values of the sensor information of the physical servers in a load state are stored in association with each other and serve as a model for the physical serves in each of the load states. The actual physical server load states are determined (estimated) by comparing sensor information measured by the actual physical server with the reference value of the sensor information for each load state shown in the reference value table 34. In the following description, the load state of the physical server that is stored in the reference value table 34 is sometimes referred to as a load pattern. The number of reference values in the load pattern and the load pattern of the reference value table 34 are not limited and may be, for example, only one.

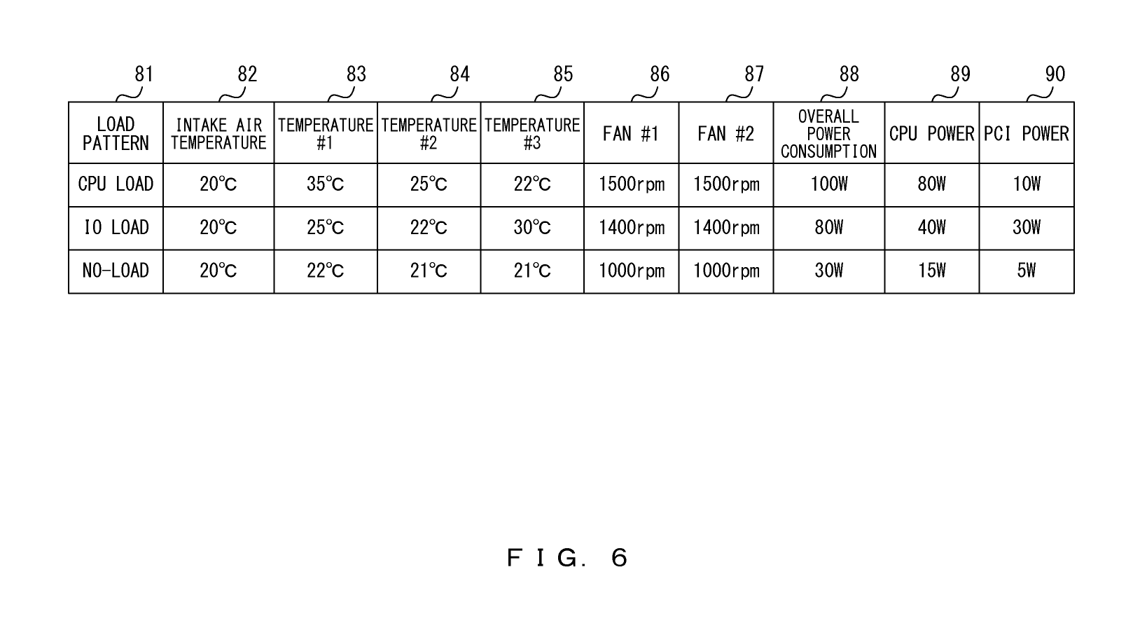

FIG. 6 illustrates an example of a configuration of the reference value table 34. In the reference value table 34 in FIG. 6, identification information identifying the load state and reference values of the sensor information at the time of such a state are stored in association with each other. The sensor information of the reference value table 34 is associated with each type of the plurality of sensors installed on the physical server.

The reference value table 34 stores the data items “load pattern” 81, “intake air temperature” 82, “temperature #1” 83, “temperature #2” 84, “temperature #3” 85, “fan #1” 86, “fan #2” 87, “overall power consumption” 88, “CPU power” 89, and “PCI power” 90 in association with each other. “Intake air temperature” 82, “temperature #1” 83, “temperature #2” 84, “temperature #3” 85, “fan #1” 86, “fan #2” 87, “overall power consumption” 88, “CPU power” 89, and “PCI power” 90 are associated with each sensor that is installed on each physical server.

The “load pattern” 81 is identification information for uniquely identifying the load pattern of the physical server. In the example of FIG. 6, the three load states of the CPU load state, the IO load state, and the no-load state are indicated. When the state of the physical server is indicated by a “load pattern” 81, the “intake air temperature” 82 indicates a reference value of the intake air temperature measured by the sensor for measuring the intake air temperature. When the state of the physical server is indicated by a “load pattern” 81, each of the “temperature #1” 83, “temperature #2” 84, and “temperature #3” 85 indicate the reference value of the temperature measured by temperature sensors for measuring temperatures in mutually different specified positions of the physical servers. When the state of the physical server is indicated by a “load pattern” 81, each of the “fan #1” 86 and “fan #2” 87 indicate the reference value of the rotational speed of the fan measured by sensors for measuring the rotational speed of the fans installed on the physical servers. When the state of the physical server is indicated by a “load pattern” 81, the “overall power consumption” 88 indicates the reference value of power consumption measured by sensors for measuring the overall power consumption of the entire physical server. When the state of the physical server is indicated by a “load pattern” 81, the “CPU power” 89 and the “PCI power” 90 each indicate the reference value of power consumption measured by sensors for measuring the power consumption of a CPU and a PCI of the physical servers.

The reference value of each sensor in each load pattern may be a value calculated on the basis of sensor information measured in the past and a load state of the server at that time. Note that each item of the sensor information of the measurement value table 31 corresponds with each item of the sensor information of the reference value table 34.

The reference value of each sensor in each load pattern may be sensor information when load of the limit of performance in each load pattern is multiplied with physical servers.

Next the load estimation unit 26 calculates the displacement value representing the difference between a load state of the physical server at the measurement value is measured and each of the load patterns by obtaining the difference between the value of each piece of sensor information of the measurement value table 31 and the reference value of the sensor information in each load pattern of the reference value table 34.

Specifically, the load estimation unit 26 calculates the sum value of a squared error of the value of each piece of sensor information for each row of the measurement value table 31 and of the value of each piece of sensor information for each row of the reference value table 34 as the displacement value of the load state at the “measurement date and time” 41 of the physical servers with respect to the load pattern. Note that, when calculating a displacement value, the load estimation unit 26 assigns weighting to each piece of sensor information according to its respective importance.

More specifically, the load estimation unit 26 first focuses on the row of the specified “measurement date and time” 41 of the measurement value table 31. Here, the row that is focused upon is referred to as the target measurement row. Then, the load estimation unit 26 calculates for each “load pattern” 81 of the reference value table 34 the difference between each piece of sensor information of the target measurement row of the measurement value table 31 and the corresponding sensor information of the reference value table 34.

For example, the load estimation unit 26 focuses on the row in which the value of the “measurement date and time” 41 of the measurement value table 31 in FIG. 3 is “2013/07/25 14:10:00” as the target measurement row. Then, the load estimation unit 26 calculates, for each row of the reference value table 34 in FIG. 6, the differences between “temperature #1” 43 and “temperature #1” 83, “temperature #2” 44 and “temperature #2” 84, and “temperature #3” 45 and “temperature #3” 85. The load estimation unit 26 also calculates, for each row of the reference value table 34 in FIG. 6, the differences between the “overall power consumption” 48 and the “overall power consumption” 88, the “CPU power” 49 and the “CPU power” 89, and the “PCI power” 50 and the “PCI power” 90. For example, the differences of the “temperature #1”, “temperature #2”, “temperature #3”, “overall power consumption”, “CPU power” and “PCI power” between the target measurement row and the row of “CPU load” are “1° C.”, “3° C.”, “3° C.”, “0 W”, “10 W”, and “0 W”, respectively.

In the present embodiment, for calculation of the displacement values, items related to the temperature and power consumption of the physical servers are assumed to be items of sensor information for calculating the difference, and the rotational speed of the fan and the intake air temperature are not included in the calculation target of the difference. That is, in the example of the measurement value table 31 in FIG. 3, “intake air temperature” 42, “fan #1” 46 and “fan #2” 47 are not included in the calculation target of the difference. That is, since the intake air temperature does not change according to the load state of the server, it is not suitable as an item for calculating the difference of the load state. The rotational speed of the fan changes according to the temperature measured by the temperature sensor, so it is sufficient to include the temperature as an item to calculate the difference between the load states.

After calculating the differences between each of the pieces of sensor information corresponding to measurement value table 31 and the reference value table 34, the load estimation unit 26 assigns weighting to each difference value by multiplying it with the value indicated by the coefficient conversion table 35 stored in advance in the storage unit 29. Out of a plurality of sensor information, information of the weighting coefficient for weighting determined on the basis of its impact on the load state or severity etc. is stored in the coefficient conversion table 35.

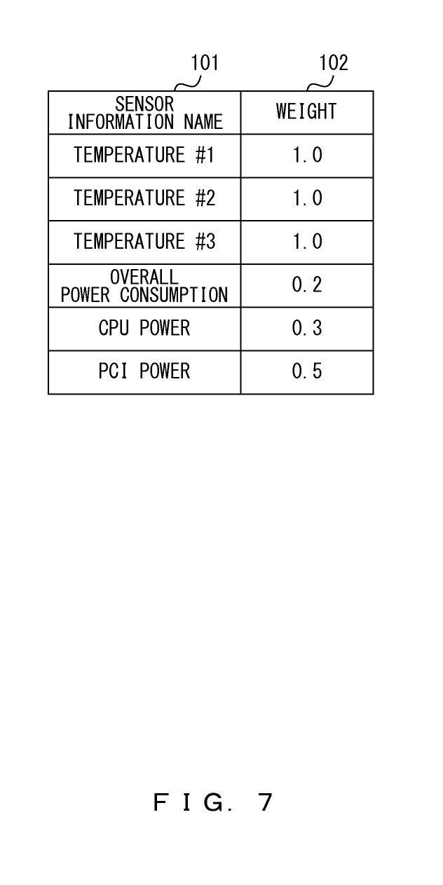

FIG. 7 illustrates an example of a structure of the coefficient conversion table 35. The coefficient conversion table 35 in FIG. 7 stores therein data items of the “sensor information name” 101 and “weight” 102 in association with each other. The “sensor information name” 101 is identification information for identifying the sensor information measured by the sensor of the physical server. The value of the “sensor information name” 101 corresponds to each item of the sensor information of the measurement value table 31 and the reference value table 34 and also corresponds to the item of the sensor information which is the calculation target of the displacement. The “weight” 102 is the set weighted value (weighting coefficient) corresponding to an importance for the sensor information indicated by the “sensor information name” 101.

In the coefficient conversion table 35 of FIG. 7, the item of the “sensor information name” 101 stores “temperature #1”, “temperature #2”, “temperature #3”, “overall power consumption”, “CPU Power”, and “PCI power”, and the corresponding weighting coefficients are respectively stored in the item of the “weight” 102.

With regard to weighting, the load estimation unit 26 obtains the weighting coefficients corresponding to the sensor information for which the differences have been calculated from the coefficient conversion table 35 and calculates the product of the obtained weighting coefficient and the calculated difference. For example, when calculating the difference between “temperature #1” of the measurement value table 31 and the reference value table 34, the load estimation unit 26 obtains “1.0” of the “weight” 102 corresponding to “temperature #1” of the “sensor information name” 101 of the coefficient conversion table 35. Then, the load estimation unit 26 performs weighting by multiplying the obtained weight “1.0” with the difference for the “temperature #1” between the measurement value table 31 and the reference value table 34. Likewise, the load estimation unit 26 assigns weighting to the differences for “temperature #2”, “temperature #3”, “overall power consumption”, “CPU power”, and “PCI Power”.

When assigning weighting as described above, the load estimation unit 26, for each piece of sensor information, squares the difference of the weighted sensor information. Then, the load estimation unit 26 calculates the total sum of the calculated values for each piece of sensor information as the displacement value.

For example, let's consider the calculation of the displacement value in the case where the respective differences for “temperature #1”, “temperature #2”, “temperature #3”, “overall power consumption”, “CPU Power”, and “PCI power” are a1, a2, a3, a4, a5, and a6, and the respective corresponding weighting coefficients are b1, b2, b3, b4, b5, and b6. In that case, the displacement value is (a1*b1)²+(a2*b2))²+(a3*b3))²+(a4*b4)²+(a5*b5)²+(a6*b6)².

As in the above manner, the load estimation unit 26 calculates the displacement value of each load pattern for the target measurement row.

Next, the load estimation unit 26 normalizes the sum of the displacement values for each load pattern so as to become “1” and calculates a displacement degree of the target measurement row for each load pattern. The displacement degree is calculated by the following equation.

Displacement degree=(displacement value)/(Σ total displacement value) (4)

Here, (Σ total displacement value) indicates the sum of displacement values for all load patterns of the sensor information of the target measurement row.

For example, when it is assumed that the displacement values of the sensor information of the target measurement row for the load patterns “CPU load”, “IO load” and “no-load” is Z1, Z2, and Z3, the displacement degree of the measurement row for the “CPU load” becomes Z1/(Z1+Z2+Z3), for example. Also, for example, the displacement degree of the measurement row for the “IO load” and “no-load”, respectively, become Z2/(Z1+Z2+Z3) and Z3/(Z1+Z2+Z3).

As in the above manner, when calculating the displacement degree of the target measurement row for each load pattern, the load estimation unit 26 stores the calculated displacement degree in the displacement table 36. The displacement table 36 stores the measurement date and time and the displacement degree with respect to each load pattern of the sensor information measured in the measurement date and time in association with each other.

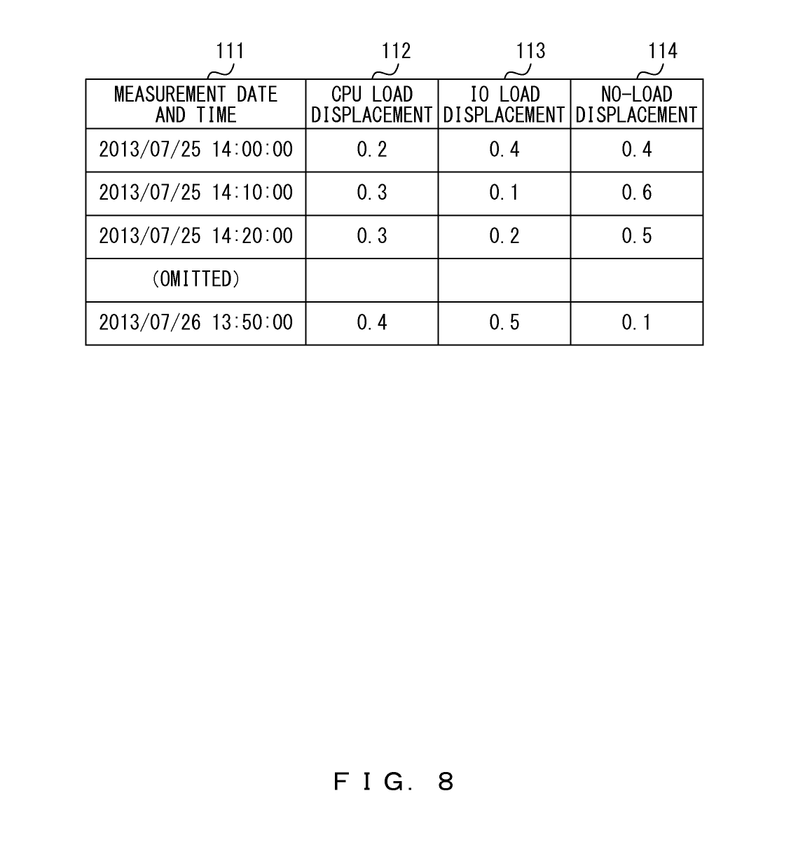

FIG. 8 illustrates an example of the displacement table 36. The displacement table 36 in FIG. 8 stores therein the data items “measurement date and time” 111, “CPU load displacement” 112, “IO load displacement” 113, and “no-load displacement” 114 in association with each other.

The “measurement date and time” 111 indicates the date and time when the measurement value of the sensor information is measured by the sensors of the physical servers. The “measurement date and time” 111 stores therein the value of “measurement date and time” 41 of the target measurement row of the measurement value table 31. The “CPU load displacement” 112 indicates the displacement degree of sensor information measured at the “measurement date and time” 111 for the load pattern indicated by the “CPU load”. The “IO load displacement” 113 indicates the displacement degree of sensor information measured at the “measurement date and time” 111 for the load pattern indicated by the “IO load”. The “no-load displacement” 114 indicates the displacement degree of sensor information measured at the “measurement date and time” 111 for the load pattern indicated by the “no-load”.

Likewise, the load estimation unit 26 focuses on another row which have another value of the “measurement date and time” 41 in the measurement value table 31 and calculates the displacement degree of the target measurement row for each load pattern and stores the calculated displacement degree in the displacement table 36.

The smaller the value of the displacement degree of the sensor information at the specified measurement date and time for the load pattern, the more similar the load states of the physical server at a specified measurement date and time and the load pattern. As described above, the load estimation unit 26 determines (estimates) the load state at the measurement date and time of the sensor information of the physical server that measured the sensor information by calculating the displacement degree indicating how different the load state of the physical servers that measure the sensor information is from each load pattern.

The suitability determination unit 27 determines the suitability of the form of provision of the provisioning server in correspondence with the load state of the physical servers estimated by the load estimation unit 26. The suitability determination unit 27 determines the suitability of the form of provision of the physical servers on the basis of the displacement table 36 and the suitability determination table 37 stored in the storage unit 29.

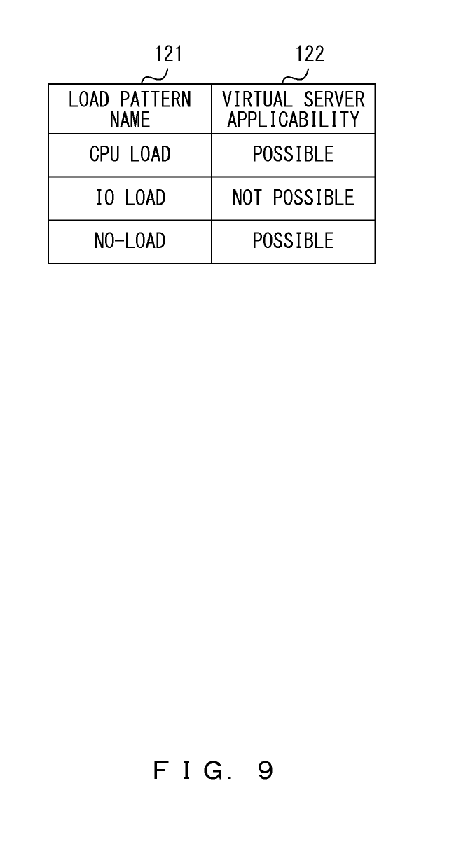

The suitability determination table 37 stores the load patterns and the suitability of the form of provisions of the physical servers in association with each other. FIG. 9 illustrates an example of the suitability determination table 37. The suitability determination table 37 in FIG. 9 stores a data item of a “load pattern name” 121 and a “virtual server applicability” 122 in association with each other.

The “load pattern name” 121 is identification information that uniquely identifies the load pattern. The “load pattern name” 121 corresponds to the “load pattern” 81 of the reference value table 34 of FIG. 6. The “virtual server applicability” 122 is information indicating whether or not the physical server is able to be applied to a virtual server (or whether the form of provision can be the virtual server) when the load state of the physical server is the load pattern indicated by the “load pattern name” 121. For example, in FIG. 9, when the load pattern is the “CPU load” or the “no-load”, it is indicated that the physical server is able to be applied to a virtual server, and when the load pattern is the “IO load”, it is indicated that the physical server is unable to be applied to a virtual server.

With regard to the determination of the suitability of the form of provision of the physical server, the suitability determination unit 27 determines whether or not the total displacement degree of the sensor information at the specified measurement date and time for the load patterns which are able to be applied to virtual servers is less than a specified threshold value. If the total displacement degree of the sensor information at the specified measurement date and time for the load patterns which are able to be applied to the virtual servers is less than a specified threshold value, then the suitability determination unit 27 determines that the physical server at the specified measurement date and time is able to be applied to a virtual server. On the other hand, if the total displacement degree of the sensor information at the specified measurement date and time for the load patterns which are able to be applied to the virtual servers is equal to or greater than a specified threshold value, then the suitability determination unit 27 determines that the physical server at the specified measurement date and time is unable to be applied to a virtual server.

For example, the suitability determination unit 27 first identifies a load pattern which is unable to be applied to a virtual server, by referring to the suitability determination table 37. In the example of FIG. 9, the suitability determination unit 27 determines that the load pattern which is unable to be applied to a virtual server is the load pattern indicated with “IO load”. Then the suitability determination unit 27, by referring to the displacement table 36, obtains the total displacement degree of the sensor information at the specified measurement date and time for the load patterns which are unable to be applied to virtual servers. For example, when calculating the total displacement degree of the sensor information at which the specified measurement date and time is “2013/07/25 14:00:00” for the load patterns which are unable to be applied to the virtual servers, the suitability determination unit 27 obtains the value “0.4” of the column of the “IO load displacement” 113 in the row where the “measurement date and time” is “2013/07/25 14:00:00”.

In the example of FIG. 9, only the load pattern indicated by “IO load” is a load pattern which is unable to be applied to a virtual server; however, when, for example, the load pattern “CPU load” is also unable to be applied to a virtual server, the suitability determination unit 27 obtains the “CPU load displacement” 112 and the “IO load displacement” 113. Then, the suitability determination unit 27 obtains the total value of the obtained “CPU load displacement” 112 and “IO load displacement” 113 in the row where the measurement date and time is “2013/07/25 14:00:00” as the total displacement degree for the load pattern which is unable to be applied to a virtual server.

As in the above manner, the suitability determination unit 27 determines whether or not the physical server at the specified measurement date and time is able to be applied to a virtual server. Then, the suitability determination unit 27 determines whether or not the physical server at the specified measurement date and time within a specified time period is able to be applied to a virtual server. If it is determined that the physical server at any measurement date and time within the specified time period is able to be applied to a virtual server, then the suitability determination unit 27 determines that the virtual server form is the suitable form of provision for the physical server. On the other hand, if it is determined even once that the physical server at any measurement date and time within the specified time period is unable to be applied to a virtual server, then the suitability determination unit 27 determines that the physical server form is the suitable form of provision for the physical server. In this way, the suitability of the form of provision can be determined on the basis of maximum resources required by the client to the provisioning server within a specified time period, by determining that the physical server is suitable for the form of provision if it is determined even once that the physical server at any measurement date and time within the specified time period is unable to be applied to a virtual server.

The output unit 28 generates and outputs an operation state report containing information for determining the suitability of the form of provision of the physical server that measures the sensor information.

The operation state report includes, in a specified period, the displacement value or displacement degree for each load pattern of the sensor information of each measurement date and time. In addition, the operation state report may include information for each reference value of the reference value table 34 corresponding to each load pattern. The operation state report may further include each load pattern and information indicating the suitability of the form of provision of the physical server associated with the load pattern. For example, the operation state report may include information of the suitability determination table 37. In addition, the operation state report may include determination result information on the suitability of the form of provision of the provisioning servers determined by the suitability determination unit 27. The operation state report may not include the determination result information on the suitability of the form of provision of the provisioning servers determined by the suitability determination unit 27.

The output unit 28 may output the suitability of the form of provision together with the load state of the provisioning server. For example, the output unit 28 may output a change in the load state of the provisioning server, where the load pattern has the smallest displacement degree for the load pattern of the sensor information at the measurement date and time as the load state of the provisioning server at that time.

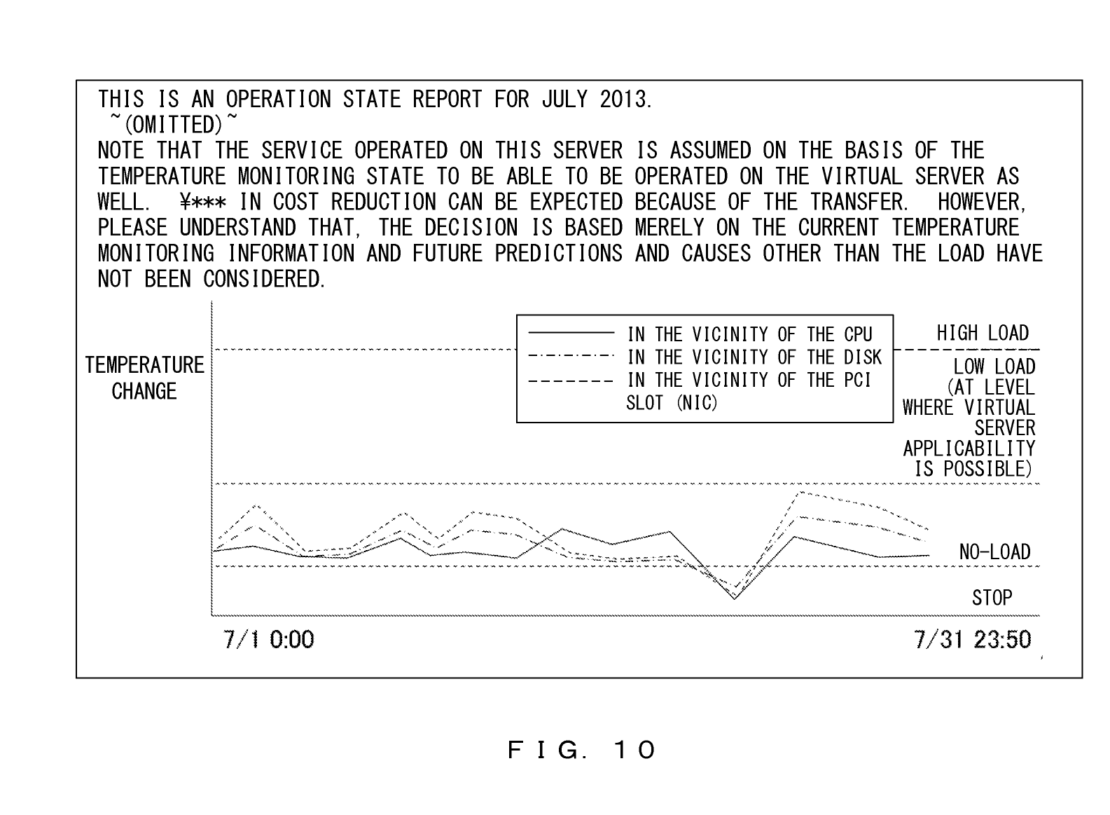

FIG. 10 is an example of an output screen output by the output unit 28. FIG. 10 gives an example of a change in a load state based on the monitored state of the temperature change measured by a plurality of temperature sensors of the provisioning server in a specified period. That is, in FIG. 10, the operation state report illustrates the displacement of the measurement value measured by each temperature sensor for each load pattern and the reference values of each load pattern. According to this, a person referring to the operation state report can grasp the operation state of the physical server in a specified period and can also obtain information for selecting the more desirable form of provision of the resources. The operation state report may also illustrate for example changes in load states based on the monitoring state of the change in power consumption at a specified time period, and may indicate a change in displacement degree. The output unit 28 may display such suitability information of the form of provision of the provisioning server and the operation state report to a user via a specified output device connected to the management server, and may transmit these to the user's terminal via a network. FIG. 10 illustrates that if the temperature change is within the range of a low load, no-load, or stop, then a physical server is able to be applied to a virtual server.

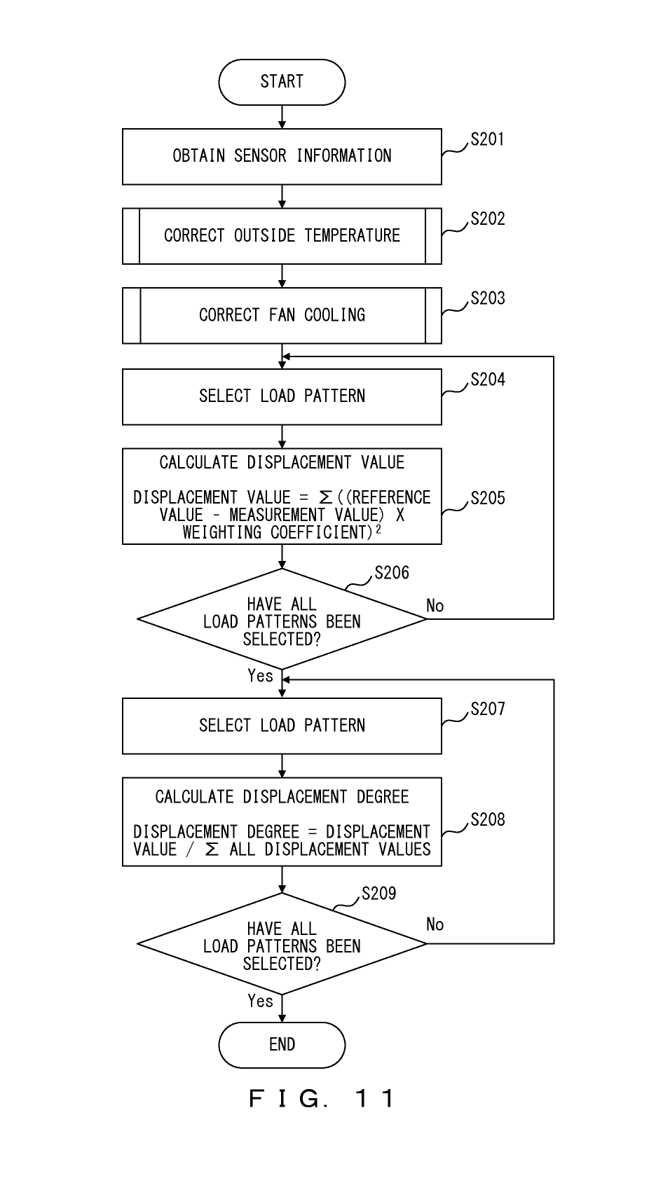

Next, an operation flow will be described for the acquisition unit 25 to obtain sensor information and for the load estimation unit 26 to estimate a load state of the provisioning server. FIG. 11 is a flow chart diagrammatically illustrating in detail processing for estimating the load state of the provisioning server. Note that the operation flow of FIG. 11 is one in which the load state is estimated in accordance with sensor information at a specified measurement date and time. Further, the flow of FIG. 11 is explained under the presumption that the sensor information at the specified date and time is regarded as a value in the target measurement row of the measurement value table 31.

In FIG. 11, the acquisition unit 25 collects the sensor information from each physical server 21 and stores the same in the measurement value table 31 (S201).

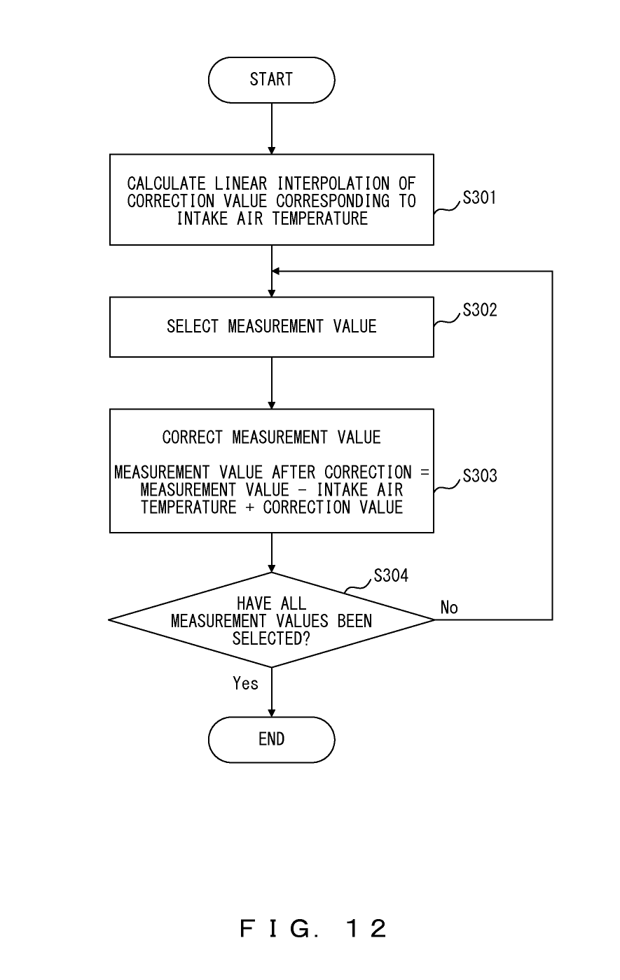

Next, the load estimation unit 26 executes an outside temperature correction for the sensor information at the specified date and time (S202). The processing flow of the outside temperature correction will be described in detail later with reference to FIG. 12.

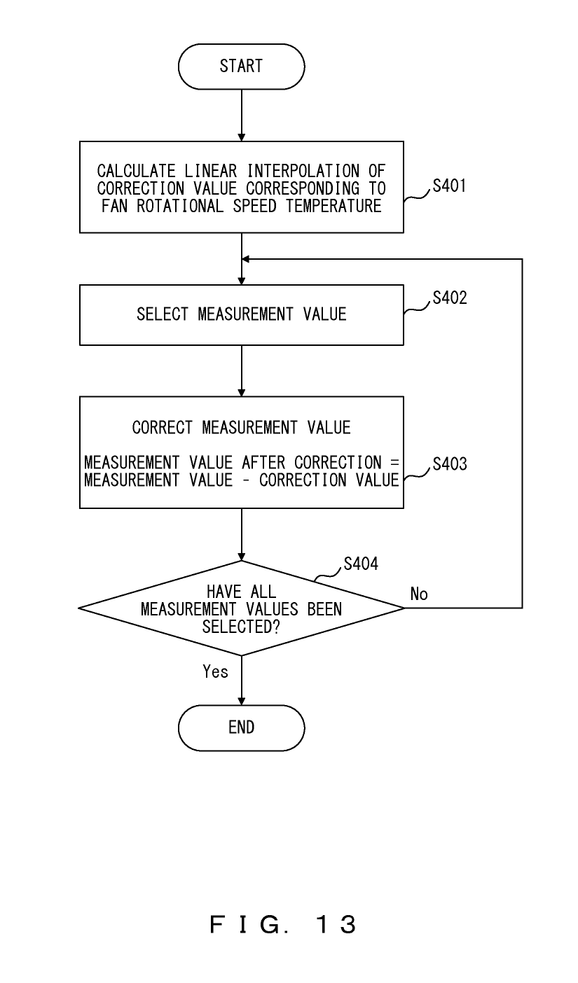

Next, the load estimation unit 26 executes a fan cooling correction for the sensor information at the specified date and time (S203). A processing flow of the fan cooling correction will be described in detail later with reference to FIG. 13.

Next, the load estimation unit 26 selects one of a specified pattern out of a plurality of load patterns illustrated in the row of the “load pattern” 81 of the reference value table 34 (S204).

Next, the load estimation unit 26 calculates a displacement value of the sensor information at the specified date and time for a load pattern selected immediately prior in step S204 (S205). That is, the load estimation unit 26 calculates a difference between each piece of sensor information at the target measurement row of the measurement value table 31 and each piece of sensor information at a row corresponding to the load pattern selected immediately in advance in S204 of the reference value table 34. Then, the load estimation unit 26 collects a weighting coefficient corresponding to each piece of sensor information on which the difference is calculated from the coefficient conversion table 35 and multiplies the collected weighting coefficient and the corresponding difference of each piece of sensor information to weight the difference. The load estimation unit 26 adds the square of the difference of each piece of weighted sensor information to calculate a displacement value. Note that the sensor information at the specified date and time is the one that has been corrected in S202 and S203.

Then, the load estimation unit 26 determines whether or not all load patterns out of a plurality of load patterns shown in rows of the “load pattern” 81 of the reference value table 34 have been selected in S204 (S206). If there are unselected load patterns out of a plurality of load patterns shown in the row “load pattern” 81 of the reference value table 34 (No in S206), the processing transitions to S204 and the load estimation unit 26 selects one of the unselected load patterns (S204).

When determining that all of the load patterns out of the plurality of load patterns shown in the row “load pattern” 81 of the reference value table 34 have been selected in S204 (Yes in S206), the load estimation unit 26 carries out the following processing. That is, the load estimation unit 26 selects one specified load pattern out of the plurality of load patterns shown in the row “load pattern” 81 of the reference value table 34 (S207). Note that the selection of the load pattern in S207 is a processing operation independent of the selection of the load pattern in S204.

The load estimation unit 26 calculates the displacement degree of the load pattern selected in S207 (S208). That is, the load estimation unit 26 first calculates the sum of the displacement values of the sensor information at the specified date and time for all of the load patterns shown in the row “load pattern” 81 of the reference value table 34. Next, the load estimation unit 26 calculates the ratio of the displacement value of the load pattern selected in S207 for the sum of the calculated displacement values. Then, the load estimation unit 26 stores a ratio of the calculated displacement values as the displacement degree in the displacement table 36.

Then, the load estimation unit 26 determines whether or not the same has selected all load patterns out of a plurality of load patterns shown in the row “load pattern” 81 of the reference value table 34 in S207 (S209). If there are unselected load patterns out of the plurality of load patterns shown in the row “load pattern” 81 of the reference value table 34 (No in S209), the processing transitions to S207 and the load estimation unit 26 selects one of the unselected load patterns (S207).

When determining that all of the load patterns out of the plurality of load patterns shown the row “load pattern” 81 of the reference value table 34 have been selected in S 206 (Yes in S206), the load estimation unit 26 terminates the processing.

Next, a processing flow of the outside air temperature correction will be described. FIG. 12 diagrammatically illustrates in detail a flow chart of outside air temperature processing. Note that an operation flow of FIG. 12 illustrates a flow of the outside air temperature correction in which sensor information at a specified date and time is assumed to be input. Further, the flow of FIG. 12 is explained under the presumption that the sensor information at the specified date and time is regarded as a value in the target measurement row of the measurement value table 31.

In FIG. 12, the load estimation unit 26 first calculates a correction value corresponding to an intake air temperature measured at a specified measurement date and time by linearly interpolating the same using the outside air temperature correction table 32 (S301). More specifically, for example, the load estimation unit 26 extracts a value of the “intake air temperature” 42 in the target measurement row of the measurement value table 31, and calculates a correction value corresponding to the value of the extracted value of the “intake air temperature” 42 by linearly interpolating the extracted value using the outside air temperature correction table 32. Note that in the outside air temperature correction table 32 if the row in which the value of the “intake air temperature” 61 is equal to the value of the “intake air temperature” 42 exists, that is, if a correction value corresponding to the “intake air temperature” 42 is stored in the outside air temperature correction table 32, S301 can be omitted.

Next, the load estimation unit 26 selects one of the measurement values out of a plurality of measured values that are subject to correction (S302). More specifically, for example, the load estimation unit 26 selects one of the values of “temperature #1” 43, “temperature #2” 44 and “temperature #3” 45 of the measurement value table 31.

Next, the load estimation unit 26 subtracts the value of the “intake air temperature” 42 from a measurement value selected immediately prior thereto in the S302, adds a correction value corresponding to the “intake air temperature” 42 to the subtracted value, and calculates a measurement value after the correction (S503). The load estimation unit 26 updates a corresponding value of the measurement value table 31 to the measurement value after the correction.

Next, the load estimation unit 26 determines whether or not the same has selected all measurement values out of a plurality of measurement values that are subject to the correction in S302 (S304). If it is determined that there are some unselected measurement values out of the plurality of measurement values that are subject to the correction (No in S304), the processing transitions to S302 and the load estimation unit 26 selects one of the unselected measurement values (S302).

On the other hand, if it is determined that all of the measurement values are selected (Yes in S304), the processing is terminated.

Next, a processing flow of the fan cooling correction in S203 of FIG. 11 will be described. FIG. 13 diagrammatically illustrates in detail a flow chart of the fan cooling correction processing. Note that an operation flow of FIG. 13 illustrates the fan cooling correction processing in which sensor information at a specified date and time is assumed to be input. Further, the flow of FIG. 13 is explained under the presumption that the sensor information at the specified date and time is regarded as a value in the target measurement row of the measurement value table 31.

In FIG. 13, the load estimation unit 26 first calculates a correction value corresponding to the rotational speed of fan at a specified measurement date and time by linearly interpolating the same using the fan cooling correction table 33 (S401). More specifically, for example, the load estimation unit 26 extracts a value of the “fan #1” 46 in the measurement target row of the measurement value table 31, and calculates the correction value corresponding to the extracted value of the “fan #1” 46 by linearly interpolating the same using the fan cooling correction table 33. Note that in the fan cooling correction table 33, if the row in which the value of “fan speed” 71 exists as a value for the “fan #1” 46 in a row of the fan cooling correction table 33, that is, if a correction value corresponding to the “fan #1” 46 is stored in the fan cooling correction table 33 of the “fan #1” 46, S401 can be omitted. The load estimation unit 26 carries out the correction processing for “fan #2” similarly to the correction processing for “fan #1”.

Next, the load estimation unit 26 selects one measurement value out of a plurality of measured values that are subject to correction (S402). More specifically, for example, the load estimation unit 26 selects one of a value of “temperature #1” 43, “temperature #2” 44 and “temperature #3” 45 of the measurement value table 31.

Next, the load estimation unit 26 subtracts the correction value corresponding to the rotational speed of fan calculated in S401 from a measurement value selected immediately prior thereto in S402 and calculates a measurement value after the correction (S403). Then, the load estimation unit 26 updates a corresponding value of the measurement value table 31 to the measurement value after the correction.

Next, the load estimation unit 26 determines whether or not the same has selected all measurement values out of a plurality of measurement values that are subject to the correction in S402 (S404). If it is determined that there are some unselected measurement values out of the plurality of measurement values that are subject to the correction (No in S404), the processing transitions to S402 and the load estimation unit 26 selects one of the unselected measurement values (S402).

On the other hand, if it is determined that all of the measurement values are selected (Yes in S404), the processing is terminated.

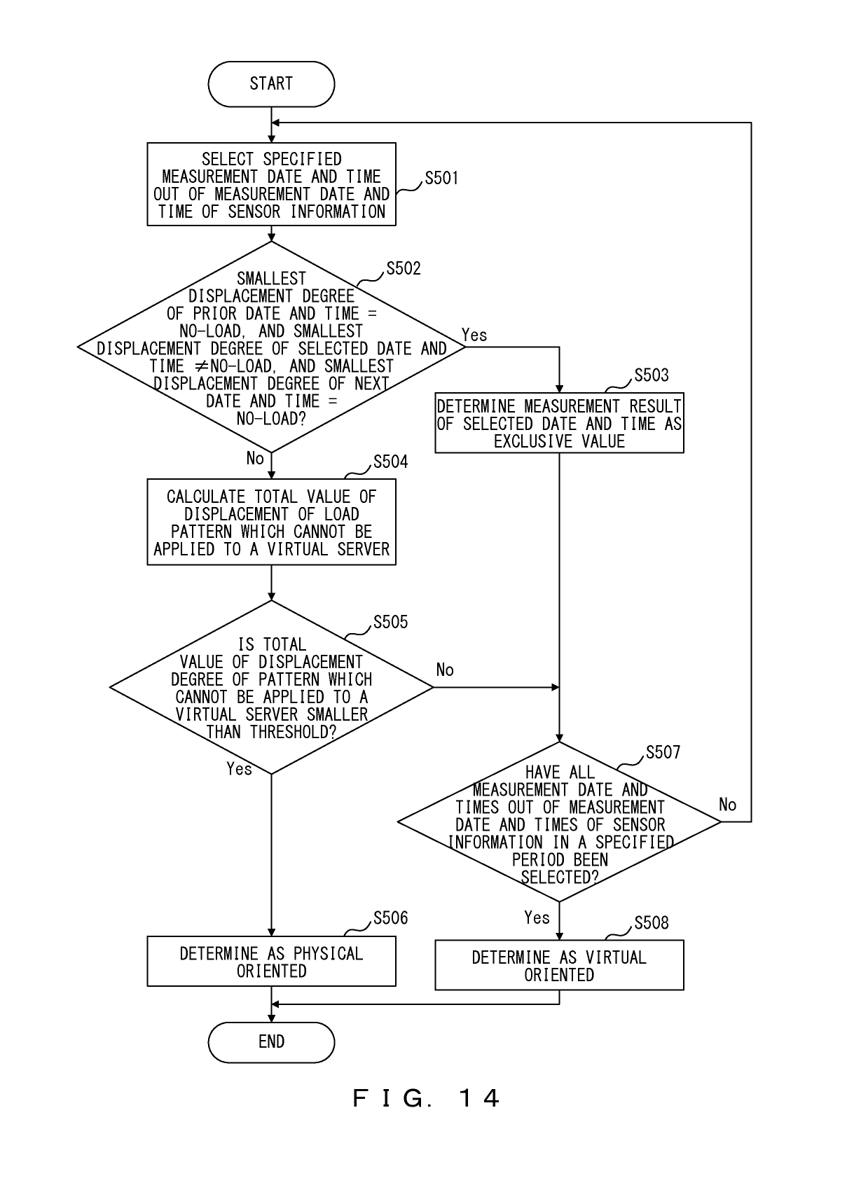

Next, an operation flow for the determination of suitability for a form of provision of a provisioning server by the suitability determination unit 27 will be described. FIG. 14 diagrammatically illustrates in detail a flow chart of the processing for determining suitability for a form of provision of a provisioning server. Note that the flow of FIG. 14 describes a processing operation for determining the suitability for the form of provision of the provisioning server in which sensor information at a specified date and time is used.

In FIG. 14, the suitability determination unit 27 selects a specified measurement date and time out of sensor information measurement dates and times (S501). That is, the suitability determination unit 27 selects a row in which the values of the “measurement date and time” 111 of the displacement table 36 is a specified measurement date and time. Note that the measurement date and time selected latest in S501 is described as a selected measurement date and time.

Next, the suitability determination unit 27 determines whether or not the load patterns of which the displacement degrees at right before and right after the selected measurement date and time are the minimum are “no-load” and whether or not that the load pattern of which the displacement degree at the selected measurement date and time is the minimum is the “no-load” (S502). More specifically, for example, in the displacement table 36 of FIG. 8, if the selected measurement date and time is “2013/07/25 14:10:00”, the measurement dates and times right before and right after the selected measurement date and time are “2013/07/25 14:00:00” and “2013/07/25 14:20:00”, respectively. Then, the minimum load pattern of which displacement degree at “2013/07/25 14:00:00” is the “CPU load” of “0.2” and the minimum load pattern of which the displacement degree at “2013/07/25 14:20:00” is “0.2” of the “CPU load”. Further, the load pattern of which the displacement degree at “2013/07/25 14:10:00” is the minimum is “0.1” of the “IO load”. Hence, in this case, the suitability determination unit 27 determines that the load pattern of which the displacement degree at right before and right after the selected measurement date and time is the minimum is not “no load”.

Then, if it is determined that the load patterns of which the displacement degrees at right before and right after the selected measurement date and time are the minimum are “no-load” and the load pattern of which the displacement degree at the selected measurement date and time is the minimum is not the “no-load” (Yes in S502), the processing transitions to S503.

In 5503, the suitability determination unit 27 determines that a measurement result at the selected measurement date and time is an excluded value (S503). In this way, the determination of suitability is not applied to a measurement value at the measurement date and time at which the load states of the physical server is similar to the load patterns which are not indicative of the “no-load” and which is interleaved between states similar to load patterns which are indicative of the “no-load”. With this treatment, a measurement value in the case where a load is suddenly generated can be excluded from the determination of suitability. Then, the processing transitions to S507.

If it is determined in S502 that one of the load patterns of which the displacement degrees at right before or right after the selected measurement date and time are the minimum are not “no-load” or the load pattern of which the displacement degree at the selected measurement date and time is the minimum is the “no-load” (No in S502), the processing transitions to S504.

In S504, the suitability determination unit 27 calculates a total value of displacement degrees at the selected measurement date and time of the load pattern which is unable to be applied to a virtual server (S504). More specifically, the suitability determination unit 27 first refers to the suitability determination table 37 and specifies a load pattern shown in the “load pattern name” 121 to which the “virtual server applicability” 122 is “not possible” as the load pattern which is unable to be applied to a virtual server. In an example in FIG. 9, a load pattern shown in the “IO load” is specified as the load pattern which is unable to be applied to a virtual server. Then, the suitability determination unit 27 obtains from the displacement table 36 a total value of the displacement degrees at the selected measurement date and time of load patterns which is unable to be applied to a virtual server. For example, if the selected measurement date and time is “2013/07/25 14:10:00” of the displacement table 36 in FIG. 8, “0.1” of the “IO load displacement” 113 is obtained.

Next, the suitability determination unit 27 determines whether or not a total value of the displacement degrees of the load patterns that is unable to be applied to a virtual server is less than a specified threshold value (“0.5”, for example) (S505). Note that, if the specified threshold value is set to “0.5”, the determination of suitability for a form of provision of a provisioning server can be carried out in accordance with whether a load pattern of a physical server at the selected date and time is closer to (the displacement degree is smaller for) the load pattern that is unable to be applied to a virtual server or the load pattern that is able to be applied to a virtual server. When it is determined that the total value of the displacement degrees of the load patterns which are unable to be applied to virtual servers is less than a specified threshold value (Yes in S505), the suitability determination unit 27 determines the form of provision of the physical server in which the measurement value is measured is suitable for a physical server (S506). Then, the processing is terminated.

On the other hand, if it is determined that the total value of the displacement degrees of the load patterns which are unable to be applied to virtual servers is equal to or more than a specified threshold value (No in S505), the suitability determination unit 27 determines whether all measurement dates and times have been selected in S501 from among measurement dates and times of the sensor information during a specified period of time (S507). Note that this period of time is within the scope of the measurement dates and times of the sensor information used for the suitability determination. If it is determined that an measurement date and time which have not been selected in S501 exists (No in S507), the processing transitions to S501 and the suitability determination unit 27 selects the unselected measurement date and time during the specified period of time (S501).

On the other hand, in S507, when determining that all measurement dates and times have been selected in S501 (Yes in S507), the suitability determination unit 27 determines that the form of provision of the physical server is suitable for the virtual server (S508). Then, the processing is terminated.

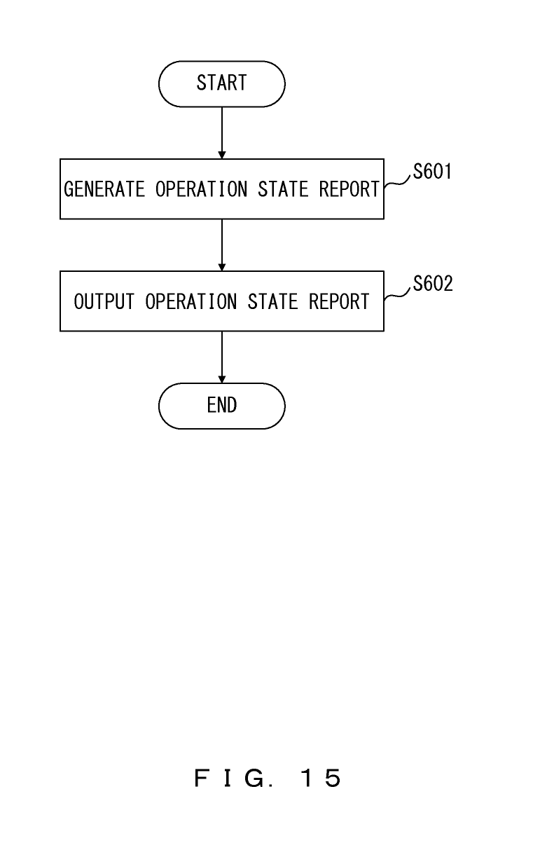

Next, an operation flow of an output processing operation by the output unit will be described. FIG. 15 diagrammatically illustrates a flow chart of the output processing operation.

In FIG. 15, the output unit 27 first generates an operation state report including information for the determination of the suitability for a form of provision of a provisioning server that has measured sensor information (S601). Then, the output unit 27 outputs the generated operation state report (S602). Then, the processing is terminated.

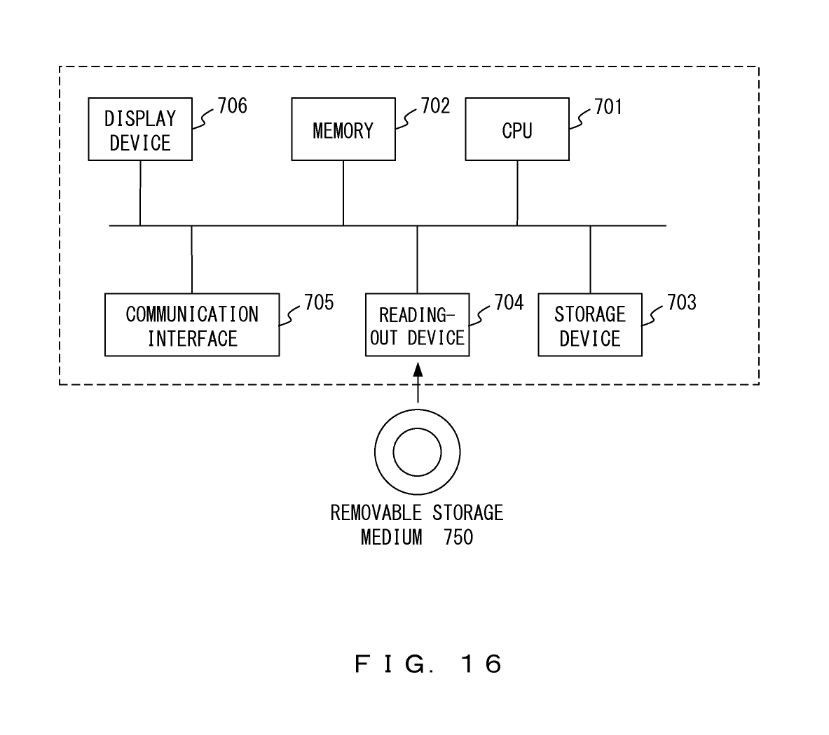

Next, a hardware structure of the management server 22 will be described. FIG. 16 illustrates an example of the hardware structure of the management server 22.

In FIG. 16, the management server 22 includes a CPU 701, a memory 702, a storage device 703, a reading-out device 704, a communication interface 705, and a display device 706. The CPU 701, the memory 702, the storage device 703, the reading-out device 704, the communication interface 705, and the display device 706 are connected via a bus.

The CPU 701 of the management server executes a program describing procedures of the flow charts mentioned above by making use of the memory 702, and provides a part or all of the functions of the acquisition unit 25, the load estimation unit 26, the suitability determination unit 27, and the output unit 28.

The memory 702 is a semiconductor memory, for example, which is configured to include a RAM (Random Access Memory) area and a ROM (Read Only Memory) area. Note that the storage device 703 can be a semiconductor memory, such as a flash memory. Further, the storage device 703 can be an external storage device. The storage device 703 provides a part or all of the functions of the storage unit 29.

The reading-out device 704 accesses a detachable memory medium 750 in accordance with an instruction of the CPU 701. The detachable memory medium 750 is materialized by a semiconductor device (USB memory, etc.), a magnetic medium (magnetic disc, etc.) in which information is magnetically input or output, and an optical medium (CD-ROM, DVD, etc.) in which information is optically input or output. Note that the reading-out device 704 may not always be included in the management server 22.

The communication interface 705 receives sensor information from each physical server 21 through a network in accordance with an instruction of the CPU 701. Further, the communication interface 705 can transmit result information of a suitability determination on a form of provision of a physical server output from the output unit 28 to a not-illustrated user terminal, for example, through the network.

The display device 706 displays information output from the output unit 28. Note that the display device cannot always be included in the management server 22.

A program of the embodiment is provided to the management server in the following form, for example:

(1) A program that is installed in the storage device 703 in advance.
(2) A program that is provided by the detachable memory medium 750.
(3) A program that is provided from a program server (not illustrated) through the communication interface 705.

Further, the management server 22 of the embodiment is partially realized by hardware. Alternatively, the management server 22 of the embodiment may be realized in a combination of software and hardware.

According to the embodiments, the display provided to a customer with information for suitably determining a form of provision of resources or result information for suitably determining a form of provision of a physical server makes it possible to urge the customer to shift to a virtual machine.

Further, a customer can verify the certainty of the selection of a form of provision in accordance with information collected from a physical server without any agent stationed in the physical server for the collection of the information. In addition, while a customer policy for the collection of information is taken into consideration, a load state of a provisioning server can be grasped.

Note that the present embodiment is not limited to the above-described embodiments, and various structures or other embodiments can be implemented without departing from the purpose of the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute process, the process comprising:
obtaining a plurality of measurement values measured by a plurality of sensors provided in a physical server;
calculating displacement values of the measurement values for the threshold values with respect to each threshold value of the load patterns which indicate combinations of threshold values of the measurement values corresponding to types of the plurality of sensors, each threshold value being stored in a storage unit; and
outputting the displacement values of the measurement values and the threshold values of the measurement values.

2. The non-transitory computer-readable recording medium according to claim 1, the process further comprising:
determining whether the physical server is able to be applied to a virtual server in accordance with the displacement values of the measurement values that is totaled for each piece of applicable information which indicate whether the physical server is able to be applied to the virtual server, the displacement values is associated with the load pattern, wherein
the outputting outputs a result of the determining.

3. The non-transitory computer-readable recording medium according to claim 2, the process further comprising:
calculating sum of differences for each load pattern between the plurality of measurement values and the threshold values corresponding to the types of the sensors that measure the measurement values, wherein
the determining determines whether the physical server is able to be applied to the virtual server in accordance with a ratio of the sum of the differences of each pattern to the sum of the differences of the plurality of patterns.

4. The non-transitory computer-readable recording medium according to claim 3, wherein
the determining determines that the physical server is able to be applied to the virtual server when the total of the ratio of the sum of differences of the plurality of patterns which is able to be applied to the virtual server to the sum of the differences of the plurality of patterns is less than a specified threshold value.

5. The non-transitory computer-readable recording medium according to claim 1, wherein
the calculating corrects the plurality of measurement values in accordance with correction information that is not dependent on a load state of the physical server and calculates a displacement values between the corrected measurement values and the threshold values corresponding to the types of the sensors that have measured the measurement values.

6. An information processing method comprising:
obtaining, by a computer, a plurality of measurement values measured by a plurality of sensors provided in a physical server;
calculating, by the computer, a displacement values of the measurement values for the threshold values with respect to each threshold value of the load patterns which indicate combinations of threshold values of the measurement values corresponding to types of the plurality of sensors, each threshold value being stored in a storage unit; and
outputting, by the computer, the displacement values of the measurement values and the threshold values of the measurement values.

7. The information processing method according to claim 6, the method further comprising:
determining, by the computer, whether the physical server is able to be applied to a virtual server in accordance with the displacement values of the measurement values that is totaled for each piece of applicable information which indicate whether the physical server is able to be applied to the virtual server, the displacement values is associated with the load pattern, wherein
the outputting outputs a result of the determining.

8. The information processing method according to claim 7, the method further comprising:
calculating, by the computer, sum of differences for each load pattern between the plurality of measurement values and the threshold values corresponding to the types of the sensors that measure the measurement values, wherein
the determining determines whether the physical server is able to be applied to the virtual server in accordance with a ratio of the sum of the differences of each pattern to the sum of the differences of the plurality of patterns.

9. The information processing method according to claim 8, wherein
the determining determines that the physical server is able to be applied to the virtual server when the total of the ratio of the sum of differences of the plurality of patterns which is able to be applied to the virtual server to the sum of the differences of the plurality of patterns is less than a specified threshold value.

10. The information processing method according to claim 6, wherein
the calculating corrects the plurality of measurement values in accordance with correction information that is not dependent on a load state of the physical server and calculates a displacement values between the corrected measurement values and the threshold values corresponding to the types of the sensors that have measured the measurement values.

11. An information processing apparatus comprising:
a storage unit that stores a load pattern indicative of a combination of threshold values corresponding to categories of a plurality of sensors provided in a physical server;
a processor that executes a process, the process including:
obtaining a plurality of measurement values measured by the sensors;
calculating a displacement values of the measurement values for the threshold values for each threshold value of the load pattern; and
outputting the displacement values of the measurement values and the threshold values of the measurement values.

12. The information processing apparatus according to claim 11, the process further including:
determining whether the physical server is able to be applied to a virtual server in accordance with the displacement values of the measurement values that is totaled for each piece of applicable information which indicate whether the physical server is able to be applied to the virtual server, the displacement values is associated with the load pattern, wherein
the outputting outputs a result of the determining.

13. The information processing apparatus according to claim 12, the process further including:
calculating sum of differences for each load pattern between the plurality of measurement values and the threshold values corresponding to the types of the sensors that measure the measurement values, wherein
the determining determines whether the physical server is able to be applied to the virtual server in accordance with a ratio of the sum of the differences of each pattern to the sum of the differences of the plurality of patterns.

14. The information apparatus according to claim 13, wherein
the determining determines that the physical server is able to be applied to the virtual server when the total of the ratio of the sum of differences of the plurality of patterns which is able to be applied to the virtual server to the sum of the differences of the plurality of patterns is less than a specified threshold value.

15. The information processing apparatus according to claim 11, wherein
the storage unit stores correction information with respect to a value that is not dependent on a load state of the physical server, and
the calculating corrects the plurality of measurement values in accordance with the correction information and calculates a displacement values between the corrected measurement values and the threshold values corresponding to the types of the sensors that have measured the measurement values.
